(19) United States
(12) Patent Application Publication
(10) Pub. No.: US 2009/0171736 A1
(43) Pub. Date: Jul. 2, 2009

(54) METHOD AND SYSTEM FOR CENTRALIZED MANAGEMENT OF SOURCES OF SUPPLY

(75) Inventors: Michael Segler, Wiesloch (DE); Thomas John, Weinheim (DE); Kristina Grunewald, Heidelberg (DE); Stefan Siebert, Hockenheim (DE); Thomas Gross-Boelting, Walldorf (DE); Bernhard Lokowandt, Heidelberg (DE); Michael Hartel, Heidelberg (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/967,976

(22) Filed: Dec. 31, 2007

(51) Int. Cl. G06Q 10/00

(52) U.S. Cl. 705/8; 705/28

(57) ABSTRACT

Methods, systems, and software for determining sources of supply are provided. The system for determining sources of supply is centralized so as to be accessible to a plurality of clients. Sources of supply may be determined and the results prioritized according to user defined criteria. Specifically, the system may offer or facilitate a reusable, centralized service that can data mine sources of supply, which are stored in a business object. These sources of supply may include transportation lane, purchase contract, scheduling agreement, material costing, and any other suitable sources of supply. In some cases, this example system can assign priorities to centralized sources of supply that may help make decisions easier for the planner.

### TECHNICAL FIELD

This disclosure relates to computer systems and methods and, more particularly, to methods and systems for identifying, determining, processing, utilizing, or otherwise managing sources of supply for a product (or service).

### BACKGROUND

Products are typically manufactured from a number of different parts, each of which may be available from a number of different sources. The determination of which sources to select as suppliers for which parts is based on a variety of criteria such as, for example, the contract terms (e.g., price) between the manufacturer and a source, the quantity of parts available from a source, and the estimated time for a source to deliver parts to the manufacturer. Depending on the number of parts and the number of possible suppliers involved, a vast amount of data may need to be considered in making such a determination. To assist with this sourcing determination, a sourcing engine, which may be one or more computers programmed with computer code enabling them to identify sources of supply based on appropriate criteria, may be used.

### SUMMARY

This disclosure relates to computer systems, software, and methods for identifying, determining, processing, utilizing, or otherwise managing sources of supply for a product (or service). In one example, software for determining a supply source comprises computer readable instructions embodied on tangible media. The software is operable to receive a request for a source determination for a product and to select at least one supply source for the product according to the request. The selected supply sources can then be enriched with at least one transportation channel and at least one quota arrangement. The software automatically prioritizes the selected supply sources based on at least a first priority rule of a plurality of priority rules, with at least one of the priority rules associated with business logic, a category associated with the product, or the product.

In another example, software for utilizing a supply source can transmit a request for a source determination for a product. The software receives a plurality of supply sources in response to the request. In this example, the received supply sources are i) enriched with the selected supply sources with at least one transportation channel and at least one quota arrangement and ii) prioritized based on at least a first priority rule of a plurality of priority rules, at least one of the priority rules associated with business logic, a category associated with the product, or the product. The software, perhaps in response to user selection or input, associates at least one of the received supply sources with the product.

Moreover, some or all of these aspects may be further included in respective systems or other similar devices for executing, implementing, or otherwise supporting such software or methods. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example system for determining sources of supply in accordance with one embodiment of the present disclosure;

FIG. 2 illustrates detailed views of various portions of the data model for a source of supply business objects in accordance with one embodiment of the present disclosure;

FIG. 3 illustrates an example method for determining sources of supply in accordance with the present disclosure;

FIG. 4 illustrates another example method for determining sources of supply in accordance with the present disclosure;

FIG. 5 illustrates an example entity-relationship diagram for sourcing prioritization rules in accordance with the present disclosure;

FIG. 6 illustrates an example method of creating sourcing prioritization rules in accordance with the present disclosure;

FIG. 7A illustrates an example hierarchy of sources of supply selection parameters in accordance with the present disclosure;

FIG. 7B illustrates an example method for enrichment of sources of supply selection parameters in accordance with the present disclosure; and

FIGS. 8A and 8B illustrate two example breakdowns of supply quota arrangements in accordance with the present disclosure.

### DETAILED DESCRIPTION

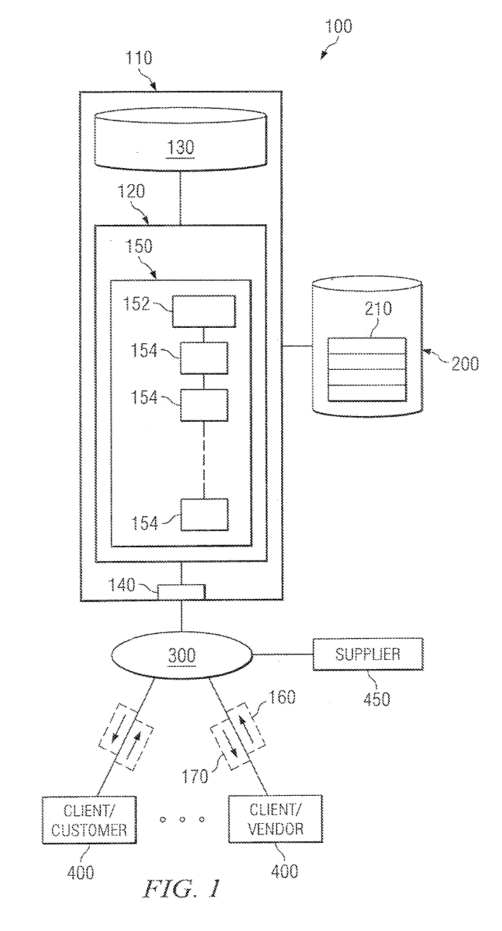

FIG. 1 illustrates an example environment implementing the various techniques. System 100 can provide high flexibility/performance through a logically centralized service or sourcing engine that is offered for heterogeneous sources of supply. For example, a source of supply may be implemented as an object that describes a logical link between a possible source of products and a possible target. In some implementations, selection of the sources of supply can use a Source of Supply business object utilizing: i) selection of static combined commercial and logistical sources of supply in one step (such as with one query); ii) selection of dynamic combined commercial and logistical sources of supply in two steps (such as with two queries); iii) procurement type dependent selection; and iv) consideration of possible call-off authorizations. This selection can be enriched for static selection parameters associated with source-of-supply-specific objects with super- and sub-ordinate objects. The example sourcing engine can also break down sources of supply, which relates super-ordinate objects to static selection parameters in consideration of nesting (enriched selection parameters) and validities. Further, the sourcing engine can merge commercial and logistical sources of supply into the consolidated Sourcing List in consideration of validities

These sources of supply may include transportation lanes, purchasing contract, scheduling agreement, material costing, production models, released planning production models, production segments, purchasing segments, and any other suitable sources of supply. For example, a transportation lane can be a connection between two locations in a supply chain model used for planning cross-location product movements, a purchasing contract can be an outline purchase agreement that contains special conditions that are negotiated between a purchaser and a seller (for example price, target value, or target quantity) that covers the supply of materials or the performance of services and can be valid for a specified period of time, and a scheduling agreement can be an outline agreement against which materials are procured at a series of predefined points in time over a certain period. System 100 can also offer extensibility by allowing the customer to define his own source of supply (such as an internal/external hybrid) and the respective business application to implement its own rules to influence the sourcing engine results (such as when one business module may want to data mine only certain sources of supply). In some cases, system 100 can data mine and then dynamically prioritize the results that can be based on customer's rules (such as internal production before external procurement). These prioritization rules can have a general part (that defines the customer's preferences) and a product specific part (sorting or prioritization requirements for that product or its category). Example sorting criteria include procurement type, fulfillment of quota, sourcing priority, and many others. For example, the customer can assign priorities to various values for each variable and the sourcing engine can load defaults values, as well (a customer may not want to assign priorities to every single variable for every single product, instead, just the special ones). The sorting criteria included in a prioritization rule may also be ranked, for example, in order of importance. System 100 may also offer dynamic quotes from various suppliers that change as prices change. Additionally, system 100 may enrich sources of supply selection parameters and generate hierarchies. For example, a product category hierarchy (e.g., a product category hierarchy, where the highest level is consumer products, which is then broken down into electronics, groceries, and perhaps further broken down). The hierarchies may be used to quickly analyze, search, and/or break down sources of supply.

At a high level, system 100 may provide a central application-independent determination and verification of master data related to sources of supply. In determining and verifying sources of supply, system 100 may consider a number of parameters (e.g., lot sizes) and the validities of one or more sources of supply. System 100 may also provide an efficient and fast interface, which includes a pre-read step with different buffer accesses possible. In some implementations, application (or customer) exit may offer the possibility to select application-specific (or customer-specific) source of supply. An output of the system 100, such as a consolidated sourcing list, may be enhanced and/or customized by an application or by customers. Generally, the sourcing system architecture may be implemented across a variety of computing platforms, user environments, and business contexts. For example, the sourcing system architecture may be useful in such processes as supplier relationship management, supply planning (such as with SCC supply planning), substitution service (such as with ATP substitution service), inter-company sales, inter- and/or intra-company stock transfer, third party direct shipping, material calculation, logistics execution, requisitioning (such as with SRM requisitioning), and others.

System 100 may be used, in some implementations, for demand matching in a substitution service. In demand matching implementations, the substitution service may use the system 100 to generate a list of sites to which the required material can be delivered. In addition, the substitution service may use the system 100 to filter sources of supply using parameters such as customer location and/or transportation zone and material. The substitution service may also use other features of system 100, such as a sources of supply purchasing contract (e.g., of type third-party order processing), outbound delivery relationships (e.g., transportation lanes), and/or inbound supply quota arrangements. A quota arrangement defines requirements and issues related to the distribution of material to different sources of supply, business partners, or internal organizational units. Also, for the purposes of this disclosure, a business partner refers to a person, organization, group of persons, or group of organizations in which a company has a business interest. A business partner may also refer to a person, organization, or group within the company, when appropriate.

In supply planning implementations, system 100 may, for example, create receipts in interactive production planning during a planning run, either automatically or manually. Additionally, system 100 may filter sources of supply using parameters such as supply planning area and material, and may provide required parameters such as lotsize quantity and requirement time. A supply planning area may refer to an area in planning for which the availability of materials on time may be guaranteed. To achieve this, the supply planning area may group requirements, stocks, and further requirement coverage elements of a site for consumption in the net requirements calculation in material requirements planning. In supply planning, other features of system 100 may also be used, such as the sources of supply production model/released planning production model, purchasing contracts, stock transfer relationships, and/or inbound supply quota arrangements.

In requisitioning implementations, system 100 may, for example, provide a required lotsize quantity. In the requisitioning business context, system 100 may also be used (either automatically or manually) during a variety of processes, which may include receipt of external requirements, shopping cart creation (for example, in a self-service procurement), processing in a sourcing cockpit, and/or processing in a purchase order. Moreover, the system 100 may filter sources of supply using a variety of parameters (e.g., product categories, product, sender business partner and recipient organizational center, validity period, recipient location, purchasing organization, catalogue reference, and product seller ID, etc.). An organizational center refers to a business unit within an organizational structure (for example, organizational plan, financial structure, geographical structure) of a company. In requisitioning implementations, other features of the system 100 (such as the sources of supply, purchasing contracts, and scheduling agreements, and/or inbound supply quota arrangements), may be used.

Additionally, the system 100 may enrich selection parameters for sources of supply with super- and sub-ordinate objects. For example, sources of supply may be enriched with means of transportation maintained on the transportation lane. In addition, a particular product may be enriched by associating the product with a product category and a product sub-category, creating a hierarchical structure. The hierarchical structure may be used to efficiently identify and/or break down sources of supply. For example, a particular source of supply may be valid for a first part of a selected time period, but not for a second part of the selected time period, and the system 100 may use the enriched selection parameters to split the source of supply over the two parts of the selected time period. Moreover, system 100 often offers estimation of the “lateness” of future delivery of supply. For example, the user can supply various parameters (such as maximum “lateness,” or a date/time range that the source of supply must be valid) that can automatically filter results. In this example, system 100 might maintain supply information such as transportation duration (truck is slower than train is slower than airplane), and special transportation requirements (milk not to be shipped with gasoline). System 100 may also analyze these sources of supplies at a company level, at a site level, and so forth, and may divide the production model into segments (divide the production of a pencil into wood production and lead production); the sourcing engine can dynamically respond to various situations that arise in this segmentation (the wood shipment is damaged, so the sourcing engine should quickly respond).

In even further implementations, system 100 may automatically learn from product movement and may offer determination of sales determination as the source of supply to the customer—a “push” feature. System 100 may also process “abstract” costs in addition to “real” costs, in dollars and cents; preferred vendor status; transportation time; product quality; rough capacity decisions for bottlenecks; complexity of order process or legal hurdles; “feelings;” and other reputation metrics. The sourcing engine can typically perform material costing estimates for multiple vendors; for example, the sourcing engine may reduce purchase costs in order to meet pricing demands from customers.

The system 100 can include, execute, request execution of, or be otherwise operable, to implement a number of processes. Some of the processes may include: i) selection of sources of supply according the given filter criteria, ii) breakdown of read sources of supply, iii) selection of means of transportation, iv) breakdown of read means of transportation, v) enrichment of the sources of supply with the means of transportation, vi) selection of the possible maintained quota arrangements, vii) breakdown read quota arrangements, viii) enrichment of the sources of supply (including the means of transportation with the quota arrangements), ix) calculation of fulfillment levels and lead times, x) business checks, xi) business add-ins (BADI) call to change the selected sources of supply, xii) determination of the relevant priority rule (which may contain sourcing application relevant sort instructions), and xiii) sorting of the sources of supply according the priority rule so that the high prioritized one are on the first position of the source list. The system 100 may also include processes for determination of the fulfillment quantities and amounts to calculate the fulfillment levels for the target quantity, target amount, guaranteed minimum amount, and the quota rate. The quota rates may persist at the quota arrangement item for final delivered receipts. Other relevant quantities and amounts of the remaining receipts may be determined during the run time over a call-back into the calling application to correct the persisted quota rates.

The system 100 may be based on a number of business objects. For example, business object SourceOfSupply may contain information relating to internal and external procurement possibilities, such as purchasing contract, scheduling agreement, stock transfer relationship based on transportation lane, and outbound delivery relationship based on transportation lane, production model/released planning production model. Generally, external (or, alternatively, internal) procurement refers to the procurement of raw materials, operating supplies, trading goods, and services from external (or alternatively internal) suppliers for the organizational units of an enterprise that need such items or services. For example, the system 100 may allow selection of static combined commercial and logistical sources of supply in one step (i.e., with one query), as well as selection of dynamic combined commercial and logistical sources of supply in two steps (i.e., with two queries). System 100 also provides procurement type dependent selection of sources of supply and consideration of call-off authorizations. Commercial and logistical sources of supply may, in some implementations, be merged into the consolidated sourcing list in consideration of validities. Other business objects that may be used by the system 100 are SupplyQuotaArrangement and TransportationLane (which may include, for example, stock transfer relationship, outbound delivery relationship, and/or others).

The system 100 may provide sourcing-related aggregation of applications, which may control the determination of a default sourcing profile or sourcing prioritization rule. A sourcing profile may include a summary of one or more control parameters of the system 100. A control parameter may be business-related or may enable specific steps of the source of supply determination within the system 100. A sourcing prioritization rule may include a prioritization definition, prioritization criteria, possible values of the prioritization criteria, an ordering of the prioritization criteria, a ranking of the prioritization criteria, and others.

The system 100 may consider source of supply specific objects (such as means of transport or transport service level at the transportation lane), which may be important for the source of supply determination. Additionally, in some implementations, dynamic selection parameters, which inherit properties from the selected sources of supply, may be determined.

In some implementations, the system 100 may determine key figures. Persisted key figures (e.g., call-off quantity) may be determined using the business object Sourcing Allocation. Dynamic key figures (e.g., planned key figures such as call off quantity) may be determined within the calling application using an application exit. The system 100 may also accumulate key figures from a source of supply or a supply quota arrangement item. Fulfillment levels (e.g., for the target quantity or quotas), lead times (e.g., related to supplier or consumer), and lateness may also be calculated.

Turning to the illustration, sourcing system 100 includes or is communicably coupled with computer 110, one or more clients 400, one or more suppliers 450, at least some of which communicate across network 300. System 100 is typically a distributed environment that includes a variety of heterogeneous sub-systems and applications that communicate with each other. For example, the relatively centralized sourcing engine may be executed on illustrated computer 110 for utilization by various clients, partners, customers, and so on. Computer 110 comprises an electronic computing device operable to receive, transmit, process and store data associated with system 100. Computer 110 is generally intended to encompass any suitable processing device. For example, computer 110 may comprise a server. In addition, sourcing system 100 may be implemented using computers other than servers, as well as a server pool. Indeed, computer 110 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Computer 110 may be adapted to execute any operating system including Linux, UNIX, Windows Server, or any other suitable operating system.

Computer 110 includes processor 120. Processor 120 executes instructions and manipulates data to perform the operations of computer 110 such as, for example, a central processing unit (CPU), a blade, an application specific integrated circuit (ASIC), or a field-programmable gate array (FPGA). Although FIG. 1 illustrates a single processor 120 in computer 110, multiple processors 120 may be used according to particular needs, and reference to processor 120 is meant to include multiple processors 120 where applicable. In the illustrated embodiment, processor 120 executes application 150.

At a high level, the application 150 is operable to receive and/or process requests 160 from clients 400 and present results 170 to the particular client. The requests 160 include requests for sourcing determinations for a particular product or product category. The results 170 include a list of one or more possible supply sources for the product or product category identified in the request. In certain cases, the functionality of application 150 may be included in a component 152, as well as one or more subcomponents 154, each typically operable to provide some service or sub-service. In short, application 150 may be a business application offering a service-oriented architecture (SOA) or may represent one of these services or business objects, namely, a sourcing engine.

Regardless of the particular implementation, “software” may include software, firmware, wired or programmed hardware, or any combination thereof as appropriate. Indeed, application 150 may be written or described in any appropriate computer language including C, C++, Java, Visual Basic, assembler, Perl, any suitable version of 4GL, as well as others. For example, returning to the above described application, the application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while functionality of application 150 may be included within a number of components and sub-components, as mentioned above, application 150 may also be a single multi-tasked module that implements the various features and functionality through various objects, methods, or other processes. Further, while illustrated as internal to computer 110, one or more processes associated with application 150 may be stored, referenced, or executed remotely. For example, a portion of application 150 may be a service that is remotely called. Moreover, application 150 may be a child or sub-module of another software module or enterprise application (not illustrated) without departing from the scope of this disclosure.

Computer 110 may include local memory 130, which may function as a possible supplement to, or as a portion of, repository 200, discussed below. Memory 130 may include any memory or database module and may take the form of volatile or non-volatile memory including, without limitation, magnetic media, optical media, random access memory (RAM), read-only memory (ROM), removable media, or any other suitable local or remote memory component. For example, memory 130 may include, point to, reference, or otherwise store a business object repository. In some embodiments, the business object repository may be stored in one or more tables in a relational database described in terms of SQL statements or scripts. In the same or other embodiments, the business object repository may also be formatted, stored, or defined as various data structures in text files, eXtensible Markup Language (“XML”) documents, Virtual Storage Access Method (“VSAM”) files, flat files, Btrieve files, comma-separated-value (“CSV”) files, internal variables, or one or more libraries. In short, the business object repository may comprise one table or file or a plurality of tables or files stored on one computer or across a plurality of computers in any appropriate format. Indeed, some or all of the business object repository may be local or remote without departing from the scope of this disclosure and store any type of appropriate data. In particular embodiments, the business object repository may access the business objects in response to queries from clients 400.

These business objects may represent organized data relating to some project or endeavor, which may or may not be linked, with each object having one or more states related to the object. Each of the states, in turn, is associated with data that pertains to various modifiable parameters of the individual states of the object. One type of data modeling that includes multiple objects with each having multiple states, and each state having multiple instances of changes to the state's modifiable parameters, is the business object model. Briefly, the overall structure of a business object model ensures the consistency of the interfaces that are derived from the business object model. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

The business object is thus a capsule with an internal hierarchical structure, behavior offered by its operations, and integrity constraints. Business objects are generally semantically disjointed, i.e., the same business information is represented once. In some embodiments, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are generally arranged from the top to the bottom based on defined order of the business areas, e.g., finance could be arranged at the top of the business object model, with CRM below finance, and SRM below CRM. To ensure the consistency of interfaces, the business object model may be built using standardized data types as well as packages, to group related elements together, and package templates and entity templates to specify the arrangement of packages and entities within the structure.

Computer 110 may also include interface 140 for communicating with other computer systems, such as clients 400, over network 300 in a client-server or other distributed environment. In certain embodiments, computer 110 receives data from internal or external senders through interface 140 for storage in memory 130, for storage in repository 200, and/or processing by processor 120. Generally, interface 140 comprises logic encoded in software and/or hardware in a suitable combination and operable to communicate with network 300. More specifically, interface 140 may comprise software supporting one or more communications protocols associated with communications network 300 or hardware operable to communicate physical signals.

As illustrated, computer 110 is communicably coupled with a remote repository 200 over a portion of network 300. Repository 200 is any intra-enterprise, inter-enterprise, regional, nationwide, or substantially national electronic storage facility, data processing center, or archive that allows for one or a plurality of clients 400 (as well as computers 110) to dynamically store and retrieve data elements, which may include any business, enterprise, application or other transaction data and metadata. Repository 200 also includes business objects 210 that are related to various supply sources, as discussed further below. Repository 200 may be a central database communicably coupled with one or more servers, computers 110, and clients 400 via a virtual private network (VPN), SSH (secure Shell) tunnel, or other secure network connection. Repository 200 may be physically or logically located at any appropriate location including in one of the example enterprises or off-shore, so long as it remains operable to store information associated with sourcing system 100 and communicate such data to at least a subset of plurality of clients 400 (perhaps via computer 110).

Network 300 facilitates wireless or wireline communication between computer 110 and any other local or remote computer, such as clients 400 and suppliers 450. Network 300 may be all or a portion of an enterprise or secured network. In another example, network 300 may be a VPN merely between computer 110 and client 400 across wireline or wireless link. Such an example wireless link may be via 802.11a, 802.11b, 802.11g, 802.20, WiMax, and many others. While illustrated as a single or continuous network, network 300 may be logically divided into various sub-nets or virtual networks without departing from the scope of this disclosure, so long as at least portion of network 300 may facilitate communications between computer 110 and at least one client 400. For example, computer 110 may be communicably coupled to repository 200 through one sub-net while communicably coupled to a particular client 400 through another. Thus, network 300 encompasses any internal or external network, networks, sub-network, or combination thereof operable to facilitate communications between various computing components. Network 300 may communicate, for example, Internet Protocol (IP) packets, Frame Relay frames, Asynchronous Transfer Mode (ATM) cells, voice, video, data, and other suitable information between network addresses. Network 300 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 300 may be a secure network associated with the enterprise and certain local or remote clients 400.

Client 400 is any computing device operable to connect or communicate with computer 110 over network 300 using any communication link in order to request and receive supply source information from sourcing system 100. At a high level, each client 400 comprises an electronic computing device operable to receive, transmit, process and store any appropriate data associated with sourcing system 100. A client 400 may be a computing device operated by a human user, such as a procurement planner, sending a request to sourcing system 100 for a determination of supply sources for one or more products. Alternatively, client 400 may be a computing device executing an application or module which sends a request for a determination of supply sources to sourcing system 100 without any human intervention. It will be understood that there may be any number of clients 400 communicably coupled to computer 110.

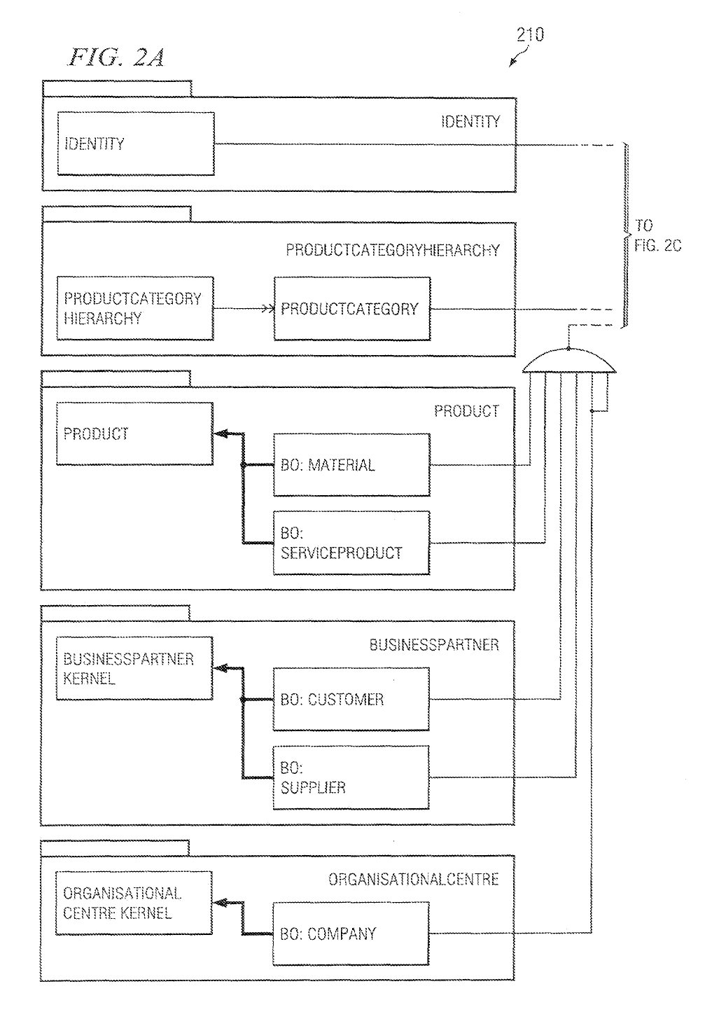

FIG. 2 illustrates an example data model for representing Sources of Supply that provides an overall view of the data model. The example Sources of Supply business object (“SOS BO”) illustrated in FIG. 2 may be used to represent a source for the external and internal procurement of products. This SOS BO contains a business relationship and an option for producing products or for procuring them internally, as well as lot size margins and costs.

As shown in FIG. 2, the example SOS BO may refer to the following original business objects, or adopt data from them: ProductionModel, TransportationLane and PurchasingingContract. The example SOS BO may occur in the following complete and disjoint specializations: ExternalProcurementSourceOfSupply (a source of supply for the external procurement of products that contains all the parameters required for that purpose), InternalProcurementSourceOfSupply (a source of supply for the internal procurement of products that contains all the parameters required for that purpose) and InternalProductionSourceOfSupply (a source of supply for the internal production of materials that contains all the parameters required for that purpose). In the case of the external and internal procurement of materials, the example SOS BO may occur in the following complete and disjoint specializations: MaterialSourceOfSupply (a source of supply for the procurement of a particular material), ServiceProductSourceOfSupply (a source of supply for the procurement of a particular service), ProductCategorySourceOfSupply (a source of supply for the procurement of products in a particular product category), and AllMaterialsSourceOfSupply (a source of supply that can be used for the procurement of all materials).

The example SOS BO may have a root node containing the following example elements, which may be defined by a data type SourceOfSupplyElements:
UUID—Universal identifier of the source of supply.
SystemAdministrativeData—The administrative data recorded by the system. This data may include system users and change dates/times.
SenderBusinessPartnerUUID—Business partner that sends the product to be procured.
SenderOrganisationalCentreUUID—OrganisationalCentre that sends the product to be procured.
SenderOrganisationalCentreBusinessCharacterCode—Coded representation of the business role of the SenderOrganisationalCentre. Possible value is ‘Company’.
RecipientBusinessPartnerUUID—Business partner that receives the product to be procured.
RecipientOrganisationalCentreUUID—OrganisationalCentre that receives the product to be procured.
RecipientOrganisationalCentreBusinessCharacterCode—Coded representation of the business role of the RecipientOrganisationalCentre. Possible value is ‘Company’.
BaseObjectNodeReference—Universal reference of the object from which the source of supply was replicated. A source of supply may be replicated from a material specific transportation lane, from an item of a purchasing contract, or a production model. The UUID should be specified, the ObjectNodeId should not be specified.
ProductUUID—Universal identifier of the product to be procured.
ProductTypeCode—Coded representation of the type of the product to be procured. The possible types are: Material and ServiceProduct.
ProductCategoryHierarchyProductCategoryUUID—Universal identifier of the product category to be procured.
ProductsSpecificationDetailLevelCode—Coded representation of the type of the specification level of the product to be procured.
CatalogueReference—Unique reference to a catalog or an object in a catalog.
ProductSellerID—An identifier that a party assigns to a product.
ProcurementCategoryCode—Coded representation of the procurement category.
PriorityValue—Priority according to which the source of supply is taken into account in procurement.
ValidityPeriod—Validity period of the source of supply.
MinimumLotsizeQuantity—Smallest possible lot size during procurement.
MinimumLotsizeQuantityTypeCode—Coded representation of the type of the MinimumLotsizeQuantity.
MaximumLotsizeQuantity—Largest possible lot size during procurement.
MaximumLotsizeQuantityTypeCode—Coded representation of the type of the MaximumLotsizeQuantity.
TargetQuantity—Target quantity for a material to be delivered, for example, in a contract item.
TargetQuantityTypeCode—Coded representation of the type of the TargetQuantity.
PlannedDeliveryDuration—Planned delivery time, including transportation time.
PlannedDeliveryDurationRelevanceIndicator—Indicates whether the PlannedDeliveryDuration has to be considered.
Status—Current status of the SourceOfSupply. It is defined by the data type SourceOfSupplyStatus. It consists of the following status variables: LifeCycleStatusCode (describes stages in the life of a SourceOfSupply).

The example SOS BO of FIG. 2 may have the following inbound aggregation relationships:
From the business object PurchasingContract/Item: PurchasingContractItem—The purchasing contract item for which the source of supply was created.
From the business object TransportationLane/ValidMaterials: TransportationLaneValidMaterials—The material-specific transportation lane from which the source of supply was created.
From the business object ProductionModel: ProductionModel—The ProductionModel for which the source of supply was created.

The example SOS BO of FIG. 2 may have the following inbound association relationships:
From the business object Supplier: Supplier—Supplier of the material to be obtained.
From the business object Customer: Customer—Customer of the material to be obtained.
From the business object Company: SenderCompany—A financially and legally independent, geographically unbound organizational center registered under business law. Sender of the material to be obtained.
From the business object Company: RecipientCompany—A financially and legally independent, geographically unbound organizational center registered under business law. Recipient of the material to be obtained.
From the business object Material: Material—The material for the material-specific source of supply.
From the business object ServiceProduct: ServiceProduct—The service for a service specific source of supply.
From the business object ProductCategoryHierarchy/ProductCategory: ProductCategory—The product category for the product-category-specific source of supply.
From the business object Identity: CreationIdentity—Identifies the Identity that created the SourceOfSupply.
From the business object Identity: LastChangedIdentity—Identifies the Identity that changed the SourceOfSupply
   In the example SOS BO of FIG. 2, the root node may have composition relationships to the following subordinate nodes: LogisticRelationship and ReferenceCollection. The example SOS BO of FIG. 2 may also include the following queries:
QueryByProductAndRecipientOrganisationalCentre: Typically provides a list of all sources of supply for a particular product and a particular organizational center that is the recipient of this product. The sources of supply can be valid for the specified point in time. The query elements can be defined by the datatype SourceOfSupplyProductAndRecipientOrganisationalCentreQueryElements which may include the following elements: ProductUUID (note: Sources of supply that refer to the product category of the specified product, to a product category on the above hierarchy level of the product category of the specified product, or to all materials, can also be returned), CatalogueReference, ProductSellerID, ProductTypeCode, RecipientOrganisationalCentreUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode, and LifeCycleStatusCode.
QueryByProductAndRecipientBusinessPartner: Typically provides a list of all sources of supply for a particular product and a particular business partner that is the recipient of this product. The sources of supply can be valid for the specified point in time. The query elements can be defined by the datatype SourceOfSupplySourceOfSupplyProductAndRecipientBusinessPartnerQuery Elements, which may include the following elements: ProductUUID (note: Sources of supply that refer to the product category of the specified product, to a product category on the above hierarchy level of the product category of the specified product, or to all materials, can also be returned), CatalogueReference, ProductSellerID, ProductTypeCode, RecipientBusinessPartnerUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode, and LifeCycleStatusCode.
QueryByProductCategoryAndRecipientOrganisationalCentre: Typically provides a list of all sources of supply for a particular product category and a particular organizational center that is the recipient of the products in this product category. The sources of supply can be valid for the specified point in time. The query elements can be defined by the datatype SourceOfSupplyProductCategoryAndRecipientOrganisationalCentreQueryElements, which may include the following elements:
ProductCategoryHierarchyProductCategoryUUID (note: Sources of supply that refer to a product category on the above hierarchy level of the product category can also be returned), RecipientOrganisationalCentreUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode, and LifeCycleStatusCode.
QueryByProductCategoryAndRecipientBusinessPartner: Typically provides a list of all sources of supply for a particular product category and a particular business partner that is the recipient of the products in this product category. The sources of supply can be valid for the specified point in time. The query elements can be defined by the data type SourceOfSupplySourceOfSupplyProductCategoryAndRecipientBusinessPartn erQueryElements, which may include the following elements: ProductCategoryHierarchyProductCategoryUUID (note: Sources of supply that refer to a product category on the above hierarchy level of the product category can also be returned), RecipientBusinessPartnerUUID, SenderBusinessPartnerUUID, RequirementDateTime, RequiredLotsizeQuantity (the system returns the sources of supply for which the RequiredLotsizeQuantity is larger or the same as the MinimumLotsizeQuantity, and for which the RequiredLotsizeQuantity is smaller or the same as the MaximumLotsizeQuantity), BaseObjectTypeCode, BaseObjectNodeTypeCode, ProcurementCategoryCode, and LifeCycleStatusCode.
QueryByProductIDAndRecipientCompanyID: Typically provides a list of all sources of supply for a particular product and a particular company that is the recipient of this product. The sources of supply can be valid for the specified point in time. The query elements can be defined by the datatype SourceOfSupplyProductIDAndRecipientCompanyIDQueryElements, which may include the following elements: Product_IdentificationProductID, ProductTypeCode, RecipientCompany_ID, RequirementDateTime, LifeCycleStatusCode, and CreationUserAccountID.
QueryByProductCategoryIDAndRecipientCompanyID: Typically provides a list of all sources of supply for a particular product category and a particular company that is the recipient of this product category. The sources of supply can be valid for the specified point in time. The query elements can be defined by the datatype SourceOfSupplyProductCategoryIDAndRecipientCompanyIDQueryElements, which may include the following elements: ProductCategoryHierarchy_ProductCategoryIDKey, RecipientCompany_ID, RequirementDateTime, LifeCycleStatusCode, and CreationUserAccountID.
QueryByProductAndRecipientOrganisationalCentreAndSenderBusinessPartner: Typically provides a list of all sources of supply for a particular product and a particular organizational centre that is the recipient of the product and a particular business partner that is the sender of this product. The sources of supply can be valid within the specified time period. The query elements can be defined by the datatype SourceOfSupplyProductAndRecipientOrgansiationalCentreAndSenderBusine ssPartnerQueryElements, which may include the following elements: ProductUUID, RecipientOrganisationalCentreUUID, SenderBusinessPartnerUUID, ValidityDateTimePeriod (note: Sources Of Supply that can be valid within this time period are returned), and LifeCycleStatusCode.
QueryByElements: Typically provides a list of all sources of supply which refer to a particular business object or to a node of a business object. The query elements can be defined by the data type SourceOfSupplyElementsQueryElements, which may include the following elements: BusinessPartnerUUID, OrganisationalCentreUUID, BaseObjectNodeReference, ProductUUID, ProductCategoryHierarchyProductCategoryUUID, and LifeCycleStatusCode.
QueryByPurchasingContractIdAndPurchasingContractItemID: Typically provides a list of all sources of supply which refer to a particular purchasing contract item. The query elements can be defined by the data type SourceOfSupplyPurchasingContractIdAndPurchasingContractItemIdQueryEle ments, which may include the following elements: ReferenceCollectionPurchasingContractID, ReferenceCollectionPurchasingContractItemID and LifeCycleStatusCode.

The example SOS BO of FIG. 2 may include a ReferenceCollection node that contains the human-readable Identifiers for the References of the SourceOfSupply. The node ReferenceCollection may contain the following elements, which may be defined by the data type SourceOfSupplyReferenceCollectionElements: PurchasingContractID (Unique identifier of a contract that defines the business relationship), PurchasingContractItemID (Unique identifier of an item of the contract that defines the business relationship), and PurchasingContractItemKey (Alternative key of the LogisticRelationshipReferenceCollection. Elements of the alternative key may include PurchasingContractId and PurchasingContractItemId).

The example SOS BO may include a LogisticRelationship node that represents a relationship between two locations that is used to procure and produce products. It defines logistical characteristics. The two locations may also be identical. This often occurs in the case of the production of materials. A logistical source of supply may reference the following original business objects: ReleasedPlanningProductionModel, PurchasingContract and TransportationLane. Also, if the goods are obtained or supplied from several geographical locations, several logistical relationships may exist for one source of supply.

The LogisticRelationship may occur in the following complete and disjoint specializations (independent of the specialization of the SourceOfSupply): ExternalProcurementLogisticRelationship (a type of logistical relationship that contains all the parameters for external procurement), InternalProcurementLogisticRelationship (a type of logistical relationship that contains all the parameters for internal procurement), and InternalProductionLogisticRelationship (a type of logistical relationship that contains all the parameters for in-house production).

The node LogisticRelationship may contain the following elements: UUID (an alternative key—Universal identifier of the logistical relationship) and SystemAdministrativeData (the administrative data recorded by the system. This data includes system users and change dates/times), SenderLocationUUID (universal identifier of the geographical starting point of the logistical relationship), RecipientLocationUUID (universal identifier of a geographical end point of the logistical relationship or the location that produces the material), SenderTransportationZoneUUID (universal identifier of the transportation zone where the procurement relationship starts), RecipientTransportationZoneUUID (universal idenfier of the transportation zone where the procurement relationship ends), SenderSupplyPlanningAreaUUID (universal identifier of the requirements planning area where the logistical relationship starts), RecipientSupplyPlanningAreaUUID (universal identifier of the requirements planning area where procurement relationship ends or the requirements planning area where the material is produced), and BaseObjectNodeReference (an alternative key—Universal reference of the object from which the logistic relationship was replicated. A logistic relationship may be replicated from a material specific transportation lane, from an item of a purchasing contract, or a released planning production model. The UUID should be specified, the ObjectNodeId should not be specified), ProcurementCategoryCode (coded representation of the procurement category), ValidityPeriod (time period during which the logistical relationship is valid), PriorityValue (priority according to which the logistical relationship is taken into account in procurement), GoodIssueDuration (duration of the goods issue process), GoodIssueDurationRelevanceIndicator (indicates whether the GoodIssueDuration has to be considered), GoodsReceiptDuration (duration of the goods receipt process), GoodsReceiptDurationRelevanceIndicator (indicates whether the GoodsReceiptDuration has to be considered), PlannedProductionFixedDuration (planned, fixed duration of production), PlannedProductionVariableDuration (planned, variable duration of production), MinimumLotsizeQuantity (smallest permitted lot size during transportation), MinimumLotsizeQuantityTypeCode (coded representation of the type of the MinimumLotsizeQuantity), MaximumLotsizeQuantity (largest permitted lot size during transportation), MaximumLotsizeQuantityTypeCode (coded representation of the type of the MaximumLotsizeQuantity), and Status (current status of the LogisticRelationship. It is defined by the data type SourceOfSupplyLogisticRelationshipStatus and may comprise the following status variables: LifeCycleStatusCode (describes stages in the life of a LogisticRelationship), SourceOfSupplyLifeCycleStatusCode (describes the LifeCycle stage of the root node), and OverallLifeCycleStatusCode (summarizes the LifeCycleStatus and the SourceOfSupplyLifeCycleStatus). In some cases, the transportation zone contains geographical locations that may be considered collectively for modeling or planning transportation routes or transportations. The zone can be defined by listing all locations that it contains, or by the attributes of the locations that it contains such as country, zip code, or region.

The LogisticRelationship node of the example SOS BO may have the following inbound aggregation relationships:
From the business object Location: RecipientLocation—Identifies the target location of the geographical point that is linked logistically.
From the business object TransportationLane/ValidMaterials: TransportationLaneValidMaterials—The material-specific transportation lane to which the source of supply refers.
From the business object PurchasingContract/Item: PurchasingContractItem—The purchasing contract item for which the source of supply was created.
From the business object ReleasedPlanningProductionModel: ReleasedPlanningProductionModel—The released planning production model to which the source of supply refers.

The LogisticRelationship node of the example SOS BO of FIG. 2 may have the following inbound association relationships:
From the business object Location: SenderLocation—Identifies the starting location of the geographical points that are linked logistically.
From the business object TransportationZone: SenderTransportationZone—Transportation zone where the procurement relationship starts.
From the business object TransportationZone: RecipientTransportationZone—Transportation zone where the procurement relationship ends.
From the business object SupplyPlanningArea: SenderSupplyPlanningArea—Identifies the initial planning area.
From the business object SupplyPlanningArea: RecipientSupplyPlanningArea—Identifies the target planning area.
From the business object Identity: CreationIdentity—Identifies the Identity that created the SourceOfSupply
From the business object Identity: LastChangedIdentity—Identifies the Identity that changed the SourceOfSupply

Also, the LogisticRelationship node of the example SOS BO of FIG. 2 may have a composition relationship to the subordinate node LogisticRelationshipReferenceCollection. The LogisticRelationship node of the example SOS BO of FIG. 2 may also include the following queries:
QueryByProductAndRecipientOrganisationalCentre: Typically provides a list of all logistical relationships for a particular product and a particular organizational center that is the recipient of this product. The logistical relationships can be valid for the specified point in time. The query elements can be defined by the GDT SourceOfSupplyLogisticRelationshipProductAndRecipientOrganisationalCentreQuer yelements, which may include the following elements: SourceOfSupplyProductUUID (note: Logistic relationships that refer to the product category of the specified product, to a product category on the above hierarchy level of the product category of the specified product, or to all materials, can also be returned), SourceOfSupplyCatalogueReference, SourceOfSupplyProductSellerID, SourceOfSupplyProductTypeCode, SourceOfSupplyRecipientOrganisationalCentreUUID, RecipientLocationUUID (logistic relationships that can be defined for RecipientLocations on the above level in the location hierarchy can also be returned; logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode, and OverallLifeCycleStatusCode.
QueryByProductAndRecipientBusinessPartner: Typically provides a list of all logistical relationships for a particular product and a particular business partner that is the recipient of this product. The logistical relationships can be valid for the specified point in time. The query elements can be defined by the GDT SourceOfSupplyLogisticRelationshipProductAndRecipientBusinessPartnerQueryEle ments, which may include the following elements: SourceOfSupplyProductUUID (logistic relationships that refer to the product category of the specified product, to a product category on the above hierarchy level of the product category of the specified product, or to all materials, can be returned), SourceOfSupplyCatalogueReference, SourceOfSupplyProductSellerID, SourceOfSupplyProductTypeCode, SourceOfSupplyRecipientBusinessPartnerUUID, RecipientLocationUUID (logistic relationships that can be defined for RecipientLocations on the above level in the location hierarchy can be returned. Logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode, and OverallLifeCycleStatusCode.
QueryByProductCategoryAndRecipientOrganisationalCentre: Typically provides a list of all logistical relationships for a particular product category and a particular organizational center that is the recipient of the products in this product category. The logistical relationships can be valid for the specified point in time. The query elements can be defined by the GDT SourceOfSupplyLogisticRelationshipProductCategoryAndRecipientOrganisationalCe ntreQueryElements, which may include the following elements: SourceOfSupplyProductCategoryHierarchyProductCategoryUUID (logistic relationships that refer to a product category on the above hierarchy level of the product category can be returned), SourceOfSupplyRecipientOrganisationalCentreUUID, RecipientLocationUUID (logistic relationships that can be defined for RecipientLocations on the above level in the location hierarchy can be returned; logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode, and OverallLifeCycleStatusCode.
QueryByProductCategoryAndRecipientBusinessPartner: Typically provides a list of all logistical relationships for a particular product category and for a particular business partner that is the recipient of the products in this product category. The logistical relationships can be valid for the specified point in time. The query elements can be defined by the data type SourceOfSupplySourceOfSupplyLogisticRelationshipProductCategoryAndRecipient BusinessPartnerQueryElements, which may include the following elements: SourceOfSupplyProductCategoryHierarchyProductCategoryUUID (logistic relationships that refer to a product category on the above hierarchy level of the product category can be returned), SourceOfSupplyRecipientBusinessPartnerUUID, RecipientLocationUUID (logistic relationships that can be defined for RecipientLocations on the above level in the location hierarchy can also be returned; logistic relationships that can be defined for a RecipientTransportationZone that contains the location can also be returned), SourceOfSupplySenderBusinessPartnerUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, SourceOfSupplyBaseObjectTypeCode, SourceOfSupplyBaseObjectNodeTypeCode, and OverallLifeCycleStatusCode.
QueryByProductAndRecipientLocation: Typically provides a list of all logistical relationships for a particular production and a particular geographical end point of the logistical relationship. The logistical relationships can be valid for the specified point in time. The query elements can be defined by the GDT SourceOfSupplyLogisticRelationshipProductAndRecipientLocationQueryElements, which may include the following elements: SourceOfSupplyProductUUID (logistic relationships that refer to the product category of the specified product, to a product category on the above hierarchy level of the product category of the specified product or to all materials can also be returned), SourceOfSupplyProductTypeCode, RecipientLocationUUID, (logistic relationships that can be defined for RecipientLocations on the above level in the location hierarchy can also be returned. Logistic relationships that can be defined for a RecipientTransportationZone that contains the location can also be returned), RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, and OverallLifeCycleStatusCode.
QueryByProductAndRecipientTransportationZone: Typically provides a list of all logistical relationships for a particular product and for a particular transportation zone where the procurement relationship ends. The logistical relationships can be valid for the specified point in time. The query elements can be defined by the data type SourceOfSupplySourceOfSupplyLogisticRelationshipProductAndRecipientTransport ationZoneQueryElements, which may include the following elements: SourceOfSupplyProductUUID (logistic relationships that refer to the product category of the specified product, to a product category on the above hierarchy level of the product category of the specified product, or to all materials, can also be returned), SourceOfSupplyProductTypeCode, RecipientTransportationZoneUUID, RequirementDateTime, RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, and OverallLifeCycleStatusCode.
QueryByProductAndRecipientSupplyPlanningArea: Typically provides a list of all logistical relationships for a particular product and for a particular requirements planning area where the procurement relationship ends. The logistical relationships can be valid for the specified point in time. The query elements can be defined by the data type SourceOfSupplySourceOfSupplyLogisticRelationshipProductAndRecipientSupplyPla nningAreaQueryElements, which may include the following elements: SourceOfSupplyProductUUID (logistic relationships that refer to the product category of the specified product, to a product category on the above hierarchy level of the product category of the specified product, or to all materials, can also be returned), SourceOfSupplyProductTypeCode, RecipientSupplyPlanningAreaUUID (logistic relationships that can be defined for RecipientLocations that belong to this supply planning area can also be returned; logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, and OverallLifeCycleStatusCode. In some cases, a supply planning area is an area in planning for which the availability of materials on time might be guaranteed. To achieve this, the supply planning area groups requirements, stocks, and further requirement coverage elements of a site for consumption in the net requirements calculation in material requirements planning.
QueryByProductCategoryAndRecipientLocation: Typically provides a list of all logistical relationships for a particular production category and a particular geographical end point of the logistical relationship. The logistical relationships can be valid for the specified point in time. The query elements can be defined by the data type SourceOfSupplyLogisticRelationshipProductCategoryAndRecipientLocationQueryEl ements, which may include the following elements: SourceOfSupplyProductCategoryHierarchyProductCategoryUUID (logistic relationships that refer to a product category on the above hierarchy level of the product category can also be returned), RecipientLocationUUID, RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), and OverallLifeCycleStatusCode.
QueryBySourceOfSupplyAndRecipientLocation: Typically provides a list of all logistical relationships that belong to a particular source of supply, have a particular geographical end point, and that can be valid for the specified point in time. The query elements can be defined by the GDT SourceOfSupplyLogisticRelationshipSourceOfSupplyAndRecipientLocationQueryEl ements, which may include the following elements: SourceOfSupplyUUID, RecipientLocationUUID (logistic relationships that can be defined for RecipientLocations on the above level in the location hierarchy can also be returned; logistic relationships that can be defined for a RecipientTransportationZone that contains the location can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, and OverallLifeCycleStatusCode.
QueryBySourceOfSupplyAndRecipientSupplyPlanningArea: Typically provides a list of all logistical relationships that belong to a particular source of supply, have a particular supply planning area at which the procurement relationship ends, and that can be valid for the specified point in time. The query elements can be defined by the data type SourceOfSupplyLogisticRelationshipSourceOfSupplyAndRecipientSupplyPlanningA reaQueryElements, which may include the following elements: SourceOfSupplyUUID, RecipientSupplyPlanningAreaUUID (logistic relationships that can be defined for RecipientLocations that belong to this supply planning area can also be returned; logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, and OverallLifeCycleStatusCode.
QueryByPurchasingContractItemAndRecipientLocation: Typically provides a list of all logistical relationships for a particular item of a particular contract and a particular geographical end point that can be valid for the specified point in time. The query elements can be defined by the data type SourceOfSupplyLogisticRelationshipPurchasingContractItemAndRecipientLocation QueryElements, which may include the following elements: PurchasingContractItemUUID, RecipientLocationUUID (logistic relationships that can be defined for RecipientLocations on the above level in the location hierarchy can also be returned; logistic relationships that can be defined for a RecipientTransportationZone that contains the location can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode, and OverallLifeCycleStatusCode.
QueryByPurchasingContractItemAndRecipientSupplyPlanningArea: Typically provides a list of all logistical relationships for a particular item of a particular contract and a particular supply planning area at which the procurement relationship ends, that can be valid for the specified point in time. The query elements can be defined by the data type SourceOfSupplyLogisticRelationshipPurchasingContractItemAndRecipientSupplyPla nningAreaQueryElements, which may include the following elements: PurchasingContractItemUUID, RecipientSupplyPlanningAreaUUID (logistic relationships that can be defined for RecipientLocations that belong to this supply planning area can also be returned; logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), RequiredLotsizeQuantity (the system returns logistical relationships for which the RequiredLotsizeQuantity is larger or the same as the MinimumLotsizeQuantity, and for which the RequiredLotsizeQuantity is smaller or the same as the MaximumLotsizeQuantity), SourceOfSupply ProcurementCategoryCode and OverallLifeCycleStatusCode.
QueryByProductIDAndRecipientSupplyPlanningAreaID: Typically provides a list of all logistical relationships for a particular product and for a particular requirements planning area where the procurement relationship ends. The logistical relationships can be valid for the specified point in time. The query elements can be defined by the datatype SourceOfSupplyLogisticRelationshipProductIDAndRecipientSupplyPlanningAreaID QueryElements, which may include the following elements: Product_IdentificationProductID, SourceOfSupplyProductTypeCode, RecipientSupplyPlanningArea_ID (logistic relationships that can be defined for RecipientLocations that belong to this supply planning area can also be returned; logistic relationships that can be defined for RecipientOrganisationalCentres that belong to locations of this supply planning area can also be returned), RequirementDateTime (the system returns logistical relationships for which the RequirementDateTime is larger or the same as the ValidityPeriodStartDateTime, and for which the RequirementDateTime is smaller or the same as the ValidityPeriodEndDateTime), OverallLifeCycleStatusCode and CreationUserAccountID.
QueryByRecipientLocationIDAndRecipientTransportationZoneID: Typically provides a list of all logistical relationships for a particular location or transportation zone where the procurement relationship ends. The query elements can be defined by the datatypeSourceOfSupplyLogisticRelationshipRecipientLocationIDAndRecipientTran sportationZoneIDQueryElements, which may include the following elements: RecipientLocation_ID, RecipientTransportationZone_ID, and OverallLifeCycleStatusCode.
QueryByElements: Typically provides a list of all logistical relationships which refer to a particular business object or to a node of a business object. The query elements can be defined by the data type SourceOfSupplyLogisticRelationshipElementsQueryElements, which may include the following elements: LocationUUID, TransportationZoneUUID, SupplyPlanningAreaUUID, BaseObjectNodeReference, and OverallLifeCycleStatusCode.
QueryByPurchasingContractIdAndPurchasingContractItemID: Typically provides a list of all logistical relationships which refer to a particular purchasing contract item. The query elements can be defined by the data type SourceOfSupplyLogisticRelationshipPurchasingContractIdAndPurchasingContractIte mldQueryElements, which may include the following elements: LogisticRelationshipReferenceCollectionPurchasingContractID, LogisticRelationshipReferenceCollectionPurchasingContractItemID, and OverallLifeCycleStatusCode.

The LogisticRelationship node of the example SOS BO of FIG. 2 may include a LogisticRelationshipReferenceCollection node that contains the human-readable Identifiers for the References of the LogisticRelationship. The node LogisticRelationshipReferenceCollection may contain the following elements, which may be defined by the data type SourceOfSupplyLogisticRelationshipReferenceCollectionElements: PurchasingContractID (Unique identifier of a contract that defines the business relationship), PurchasingContractItemID (Unique identifier of an item of the contract that defines the business relationship), and PurchasingContractItemKey (an alternative key of the LogisticRelationshipReferenceCollection). Elements of the alternative key may include PurchasingContractId and PurchasingContractItemId.

It should be noted that prior to operation of the sourcing system 100, a plurality of source of supply business objects 210 containing data representative of the various supply sources available to sourcing system 100 may have been created and stored in the business object repository 200 in memory 130 and/or some other persistence.

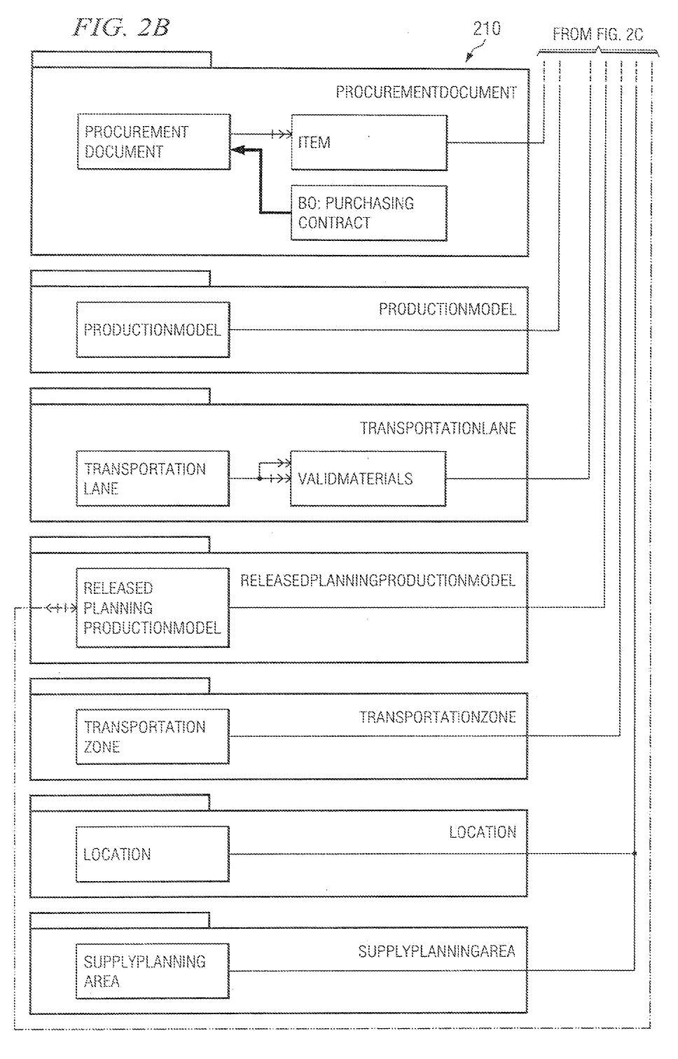

FIG. 3 is a flowchart illustrating an example method 500 according to which the sourcing system 100 may operate. First, sourcing system 100 receives a request for a source determination, as shown in block 510. For example, an application running in a client 400 calls the sourcing system 100. The application identifies a particular product, a product category, a product seller ID, or a catalog reference for which the source determination is desired. The application may also identify a product recipient such as a business partner, an organizational area, a company, a location, a transportation zone, or a supply planning area. A supply planning area may refer to an area in planning for which the availability of materials on time is guaranteed. To achieve this, the supply planning area groups requirements, stocks, and further requirement coverage elements of a site for consumption in the net requirements calculation in material requirements planning.

The application calling sourcing system 100 may control the sourcing determination process performed by the sourcing engine in a number of ways. For example, the business application may pass selection parameters to the sourcing engine. In this example, these selection parameters could be on a very detailed level (such as on Product level), but there can also be sources of supply that were maintained on a higher level (e.g., on Product-Category level). The sourcing engine may further enrich the selection with higher maintenance possibilities (such as the Product Categories and/or All-Product-Entries). A further service may break down a higher maintained source of supply to the selected criteria, indicating that the product category specific source of supply will be provided with the selected product.

Also, each application that calls the sourcing engine may have a sourcing profile associated with it. Each sourcing profile may be bundled with parameters that control the source determination process. The sourcing profile may contain a summary of the control parameters for the system 100. In addition, the calling application may be associated with a particular business configuration and each configuration can have controls, e.g., a sourcing priority rule, associated with it. Thus, when a given application associated with a given business configuration calls sourcing system 100, the sourcing engine may automatically apply the sourcing profile and controls associated with application and context.

Next, sourcing system 100 performs the source determination based on the parameters provided by or associated with the calling application, as shown in step 520.

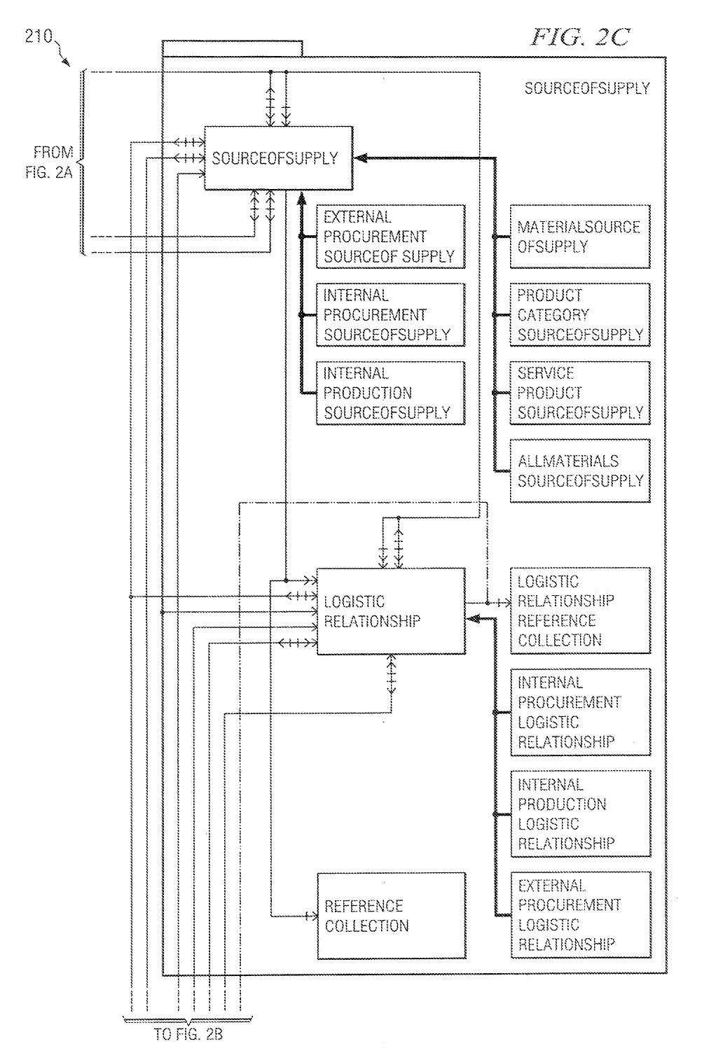

FIG. 4 is a flowchart illustrating an example method 600 followed by the sourcing system 100 in performing this source determination. As shown in FIG. 4, sourcing system 100 first selects sources of supply, as indicated in step 610. Selection of sources of supply may serve as an entry point into source determination. However, in some implementations, an entry point over means of transportation may be provided. First, sources of supply may be selected based on several filter criteria, such as product specific alternatives (e.g., product, product category, seller ID, or catalog reference), recipient specific alternatives (e.g., recipient business partner, recipient organizational center, recipient location, recipient transportation zone, or recipient supply planning area), purchasing organization, or sender business partner. Queries of the sources of supply BO may be used to select the Sources of Supply matching the filter criteria. In addition, within these queries, the filter criteria may be enriched. Examples of such enrichments include products with product categories, products with all-product-entries, recipient locations with recipient transportation zones, recipient locations with higher recipient locations of a location hierarchy, and recipient supply planning areas with recipient organizational centers.

Control parameters and filter criteria, such as from the sourcing profile for the application, may influence the sources of supply selected through the queries. For example, lotsize quantity may be used to check the lot size ranges, and earliest planning date/time or requirement date/time may be used to check the validity in dependency of the control parameter validity relation.

After sources of supply have been selected through the queries, the selected sources of supply may be broken down to more detailed levels of attributes. For example, the selected sources of supply may be broken down using the following sequence of detail levels: location related detail level sequence (e.g., location specific sources of supply, higher location specific sources of supply, and then transportation zone specific sources of supply), after location related detail level, the product specific detail level sequence (e.g., product specific sources of supply, product category specific sources of supply, and then all product entry specific sources of supply).

In some implementations, special control parameters, which may be part of the Sourcing Profile, provide a breakdown of the Sources of Supply. For example, there may be parameters to control the breakdown of cross-product specific sources of supply into product specific sources of supply (e.g., by checking the Product Supply Planning Assignment). As another example, there may be parameters to control the explosion of transportation zone specific sources of supply into location specific sources of supply. In some implementations, some objects may be broken down to selected objects. For example, product categories may be broken down to selected products and all-product-entries may be broken down to selected products. Additionally, recipient transportation zones may be broken down with selected recipient locations, and higher recipient locations of a location hierarchy may be broken down with selected recipient locations.

Also, the following methods may be used to break down the selected sources of supply: recipient transportation zone-specific sources of supply with selected recipient locations, higher recipient location-specific sources of supply with selected recipient locations of a location hierarchy, recipient organizational center-specific sources of supply with selected recipient supply planning areas, product category-specific sources of supply to selected products, and all product entry-specific sources of supply to selected products.

Following the selection and breakdown of sources of supply, sourcing system 100 selects means of transportation, as shown in step 620. This selection may be based on filter criteria such as list of means of transportation IDs, product or product category-specific transportation lane, and extracted filter criteria of the selected sources of supply, such as the valid materials-node of the transportation lane BO. Queries of the BO transportation lane may be used to select the means of transportation. In addition, within these queries, the filter criteria may be enriched. Examples of such enrichments include arbitrary means of transport to selected means of transport. Also, control parameters, perhaps from the sourcing profile for the application, may influence the means of transportation selected through the queries. For example, these parameters can include earliest planning date/time or requirement date/time to check the validity in dependency of the control parameter “Validity relation,” validity relation to the sender leads to a selection from the earliest planning date/time to the future, and validity relation to the recipient leads to a selection exactly with the requirement date/time. In some implementations, a special control parameter may switch off the breakdown of means of transport.

In some implementations, recalculation of the transportation distance and duration may be executed, for example, if a GIS-quality for the means of transport cannot be determined. Recalculation of the transportation distance and duration may be necessary, if for example, the higher means of transport contains a manually maintained, not fixed transportation distance or duration. The ratio between the manually maintained and the straight line transportation distance and/or duration may be the basis of the recalculation. This service may be independent from the structure.

After the means of transportation are selected, the higher means of transportation may be broken down to selected means of transportation IDs. The selected and broken down means of transportation may then be merged with the selected source of supply from step 610 into one Sourcing List.

Next, sourcing system 100 selects quota arrangements, as shown in step 630. The system 100 may provide a flexible selection of quota arrangements, for example, by using filter criteria and control parameters. The filter criteria for selecting supply quota arrangements may be determined from the attributes of selected sources of supply, such as product, product category, and recipient organizational center (whether it be the company or a different purchasing organization). Queries of the BO quota arrangement may be used to select the supply quota arrangements matching the filter criteria. In addition, within these queries, the filter criteria may be enriched. Any of the enrichments discussed with respect to steps 610 and 620 may also be extensible to the enrichment of quota arrangements. Examples of such enrichments include products with product categories, products with all-product-entries, recipient locations with higher recipient locations of a location hierarchy, recipient supply planning areas with recipient organizational centers, sources of supply with sender organization centers, and sources of supply with sender locations. Also, control parameters, as from the sourcing profile for the application, may influence the quota arrangement selected through the queries. Any of the control parameters discussed with respect to steps 610 and 620 may be extensible to the breakdown of quota arrangements. As another example of a control parameter that may be used with the breakdown of quota arrangement, a control parameter can control the quota direction.

After supply quota arrangements have been selected through the queries, the selected supply quota arrangements may be broken down to more detailed levels of attributes. For example, the selected supply quota arrangements may be broken down using the following sequence of detail levels: product-specific supply quota arrangements, product category specific supply quota arrangements, and all product entry-specific supply quota arrangements.

Also, the following methods may be used to break down the selected supply quota arrangements: product category specific supply quota arrangements to selected products, and all-product-entry specific supply quota arrangements to selected products. The selected and broken down supply quota arrangements may then be merged with the selected source of supply from step 610 into one sourcing list by splitting the validities.

Next, sourcing system 100 determines fulfillment quantities, as shown in step 640. One example of how this determination may be made involves first determining the allocated quantities related to sources of supply and supply quota arrangement items of non-simulated receipts with queries of the BO sourcing allocation. Then, a call-back may be made into the application that called sourcing system 100 using an application exit to determine open quantities based on sources of supply and supply quota arrangement items of simulated receipts on run time. Then, the quantities of the non-simulated and simulated receipts may be cumulated based on sources of supply and supply quota arrangement items.

In some implementations, in addition to determining fulfillment of target quantities, system 100 may determine quota rates, target amounts, and guaranteed minimum amounts. For the time-continuous distribution of receipts to the sources of supply (e.g., according the supply quota arrangements), system 100 may determine the current quantities to calculate the current quota rates. The quantities of final delivered receipts, which are relevant for a quota rate, may be saved at the supply quota arrangement item directly. Other quantities of open receipts may be determined during run time over a callback service. In this manner, it may also be possible to determine the unsaved quantities of receipts that received a source of supply during an open session. The rules to determine the relevant receipts to calculate the Quota Rates may be included in the calling application. The Quota Rate may deliver the accumulation of all receipts which are relevant for the current Quota Arrangement Item. Furthermore, the quantities and amounts of open receipts may also be relevant in, for example, the source of supply maintained guaranteed minimum amount, target amount, and target quantity.

Next, sourcing system 100 establishes or implements business checks, as shown in step 650. One way in which these business checks may be established begins with checking the validity period in dependency of the control parameter “validity relation” according to the selection parameter requirement date/time. If the validity relates to the sender, subtract the calculated consumer duration from the requirement date/time before checking the validity period. The sourcing engine may check the maximum lateness duration. The sourcing engine may also check the lotsize range according to the selection parameter lotsize quantity in consideration of the unit conversion. The sourcing engine may also check the existence of the supply planning information within the product at the sender or recipient supply planning area according the control parameter “product break down code.”

After business checks are established, sourcing system 100 determines and calculates lead times, as shown in step 660. One method through calculating lead times involves overwriting with the lead times from the BO product, if the relevance indicators of these lead times which established at the source of supply, are switched off (planned delivery duration, goods issue duration, and goods receipt duration). Also, calculation of lead times involves the following: (a) re-calculation of shipment duration in case of a source of supply, which was selected over a location and relates to a recipient transportation zone. The maintained shipment duration to the transportation zone will be recalculated in relation to the straight-line-distance to the selected location; and (b) calculation of total production planning duration (estimated duration at the source of supply).

In some implementations, in addition to determining and calculating lead times, system 100 may also calculate costs. Several costs and lead times can be maintained at the source of supply and means of transportation in a fixed and/or variable manner. Depending on the control parameters (e.g., timestamp, lot size), it is possible to calculate procurement times and/or planned delivery times and total costs. The system 100 may also determine and/or calculate dynamic attributes, such as Fulfillment of Target Quantity, Fulfillment of Target Amount, Fulfillment of Guaranteed Minimum Value, and Lateness. Next, sourcing system 100 calculates fulfillment levels, as shown in step 670. One method for doing so involves first calculating the exceeded fulfillment level of the target quantity of the source of the supply. Then, system 100 calculates the fulfillment levels of the competing supply quota arrangement items in relation to each other. The fulfillment level of target quantity may also be calculated by using fulfilled quantities from the relevant receipts and/or final delivered quantities (which are cumulated at the sources of supply). The fulfillment level of target amount may be calculated by using fulfilled amounts from the relevant receipts and/or final delivered amounts (which are cumulated at the sources of supply). The fulfillment level of guaranteed minimum amount may be calculated by using fulfilled amounts from the relevant receipts and/or delivered amounts (which are cumulated at the sources of supply). The system 100 may also provide a sub-service to determine planned delivery duration, goods issue duration, and goods receipt duration, from the supply planning assignment of materials.

Sourcing system 100 then calculates the lateness of providing a source of supply, as shown in step 680. Here, lateness describes the time a material will be provided after the requirement time has been given by the application. To determine the lateness, an efficient scheduling calculation can be performed according to various scheduling parameters with source determination considering lead time and validity calculation of lateness duration with the difference of the requirement time and the current, and the sum of supplier and consumer lead time.

For example, scheduling parameters for the internal production procurement possibility may include production duration (estimated duration at the source of supply) related to the production calendar and factory calendar calculation of the consumer and supplier lead time source determination considering lead time and validity calculation of lateness duration with the difference of the requirement time and the current and the sum of supplier and consumer lead time.

In another example, scheduling parameters for the external procurement possibility can include planned delivery duration (source of supply/material master) related to the supplier calendar (ship-from location), goods receipt processing time (source of supply/material master/transportation lane) related to the factory calendar calculation of the consumer, and supplier lead time and the current, and the sum of supplier and consumer lead time.

In yet another example, scheduling parameters for the internal stock transfer procurement possibility can include goods issue processing time (source of supply/material master/transportation lane) related to the factory calendar (ship-from location), transportation duration (transportation lane) related to the transportation calendar (means of transportation), goods receipt processing time (source of supply/material master/transportation lane) related to the factory calendar (recipient location), and calculation of the consumer and supplier lead time. Generally, stock transfers include exchange of material between organizational centers, each of which are a business unit within an organizational structure (for example, organizational plan, financial structure, geographical structure) of a particular company.

In a further example, scheduling parameters for the 3rd party direct ship procurement possibility can include planned delivery duration (source of supply/material master) related to the supplier calendar (ship from location) and transportation duration (transportation lane) related to the transportation calendar (means of transportation). Calculation of lateness duration is achieved by the difference of the requirement time and the current, and the sum of supplier and consumer lead time.

In some implementations, after establishing business checks and calculating lead times, fulfillment levels and lateness, the system 100 may use business add-ins to change or enhance the prepared sourcing list. Changing or enhancing a prepared sourcing list may, in some implementations, be implemented before prioritization of selected sources of supply.

Referring again to FIG. 4, sourcing system 100 finds and applies sourcing priority rules, as shown in step 690. In the application of sourcing priority rules, the sourcing list may be extensible to means of transport and/or supply quota arrangement. Application of priority rules may bring sources of supply into a proper prioritization, automatically choosing the most favorable source of supply. The priority rules may depend from the following objects: processes, product categories, and/or products. If more than one priority rule is valid, then a highest ranked or a most preferred rule may be applied. One way to apply sourcing priority rules involves first finding the relevant sourcing priority rule by the sourcing application code or the optional control parameter sourcing priority rule code. Next, sourcing system 100 finds the appropriate sub-priority rule within the selected sourcing priority rule for competing sources of supply in consideration of the following detail level sequence: product specific sourcing sub-priority rule, product category specific sourcing sub-priority rule, general sourcing sub-priority rule. Then, sourcing system 100 sorts the sourcing list according to the sort criteria within the sourcing sub priority-rule. The sourcing priority rule and the default sourcing-sub-priority rule may be found according to the sourcing application. Optionally, the sourcing sub-priority rules may be found by products or product categories. The result shall be a sorted list according the priority rules. For example, sourcing priority rules can be dedicated to products, product categories, or others that are generally usable. In this example, the most detailed (special) sourcing priority rule can be dedicated to a product. If the sourcing engine doesn't find a product-specific one, say, because the customer maintained it on a higher level, then the sourcing engine can look for a product category-specific one. The highest definition of a sourcing priority rule is often a general one, and the sourcing engine takes this one, if no product-specific, product category-specific, or other middle tier one were found.

Sourcing system 100 may also allow sorting of the sources of supply by each attribute of the output structure, e.g., the sourcing list. The attributes have to be classified by:
Static attributes: value given by property of the source of supply (e.g., priority of source of supply, procurement type, source object type, or selling party);
Dynamic attributes: value calculated for each source, when sourcing engine is called (e.g., costs, lateness, fulfillment of guaranteed minimum value, or quota rate);
Numerical attributes: rank of sources of supply can be directly derived; direction of sorting is inherently given (e.g. priority of source of supply, costs, lateness, fulfillment of guaranteed minimum value, or quota rate); and
Non-numerical attributes: surrogate needed to express preferences like a priority, which is assigned to particular attribute values (e.g., procurement type, source object type, or selling party).
   The sourcing system 100 may use a default prioritizing rule. In an embodiment, the default prioritizing rule prioritizes based on at least one of the following example criteria: priority of source of supply, procurement type, quota rate, source object type, lateness duration, and fulfillment of target quantity. A user may configure the default prioritizing rule by selecting the criteria used by the rule. The system 100 may give an explanation of the current source determination, which clarifies why the current sources were determined and why the current sources were sorted in a given order.

Returning to FIG. 3, the sorted sourcing list is returned to the application that called the sourcing engine, as shown in block 530. In some implementations of the methods illustrated in FIGS. 3 and 4, the following parameters may control the sourcing process within the system 100: relevance indicators for each sub-service of the system 100, procurement level code, sales process relevance indicator, relevance indicator—cost calculation, validity relation, product breakdown code, transportation zone breakdown code, relevance indicator—unit conversion, relevance indicator—transport means special rules, transport means breakdown code, check indicator—product procurement type.

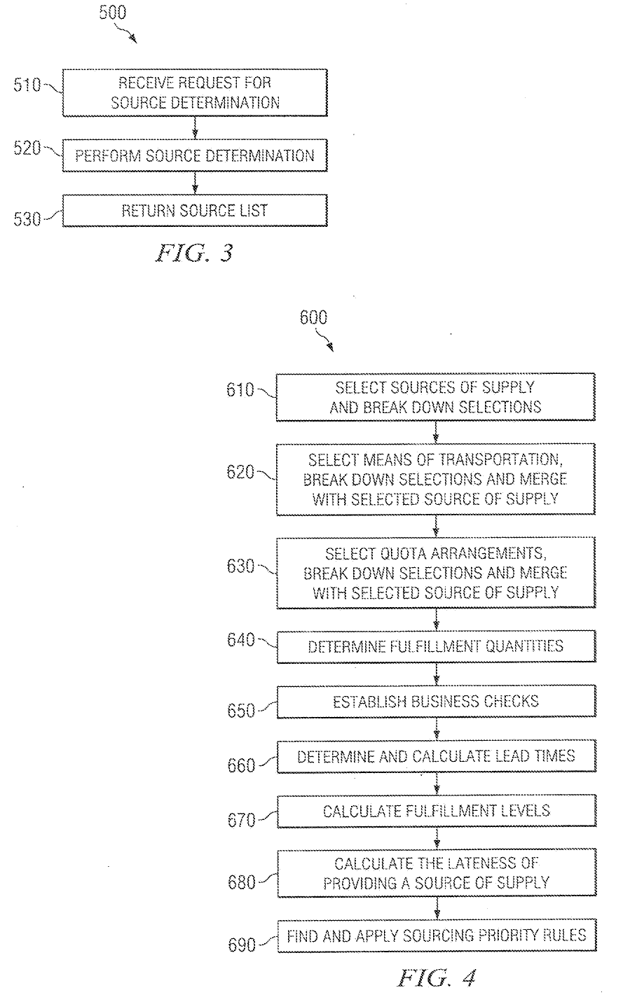

FIG. 5 illustrates an example entity relationship diagram 700 of sourcing prioritization rules in accordance with the present disclosure. In diagram 700, entities of a relational database are illustrated as tables, and arrows indicate relationships among the entities. At a high level, diagram 700 includes seven tables.

Each entity represented in diagram 700 may include a plurality of attributes, and one or more attributes may be designated keys. The right column of each table lists some of the attributes that may be associated with the particular entity represented by the table. An entity represented in diagram 700 may have one or more attributes that are not listed in the table. The left column of each table indicates whether or not a listed attribute is a designated key. A primary key (identified by ‘PK’ in the left column of a table) may uniquely identify an individual record within an entity. A foreign key (identified by ‘FKN’ in the left column of a table, where N is an integer) may uniquely identify a record within a different entity. For example, a foreign key for one entity may be a primary key in a different entity. In a specific example, the attribute SrcPrioRlCode 712 is a primary key PK 714 for entity SOS_I_PrioRl 710 and a foreign key FK2 722 for entity FDT 720 and entity SOS_C_PRIORLDFLT 730.

The sourcing prioritization rules contain application relevant sort instructions which allow sources of supply to be sorted so that, for example, the highly prioritized sources of supply may be on or near the first position of the source list. The sourcing prioritization rules may provide a dynamic mechanism to prioritize sources of supply in a proper or desirable order. The prioritization of sources of supply may allow the most favorable source of supply to be chosen. In some implementations, a default prioritization rule that is used to determine the source of supply may be configured. In such implementations, it may be possible to configure the criteria used by the default prioritization rule, the ranking of the criterion used by the default prioritization rule, and the prioritization of the possible values of each criterion used by the default prioritization rule. In some implementations, at least one criterion (e.g., priority of source of supply, cost, procurement type, quota rate, source object type, lateness, fulfillment of guaranteed minimum value, selling party, supply planning area) may be selected. Also, the scope of application of a prioritization rule and/or a ranking of criteria may be configured. For example, the scope of application may be the process, product and/or product group for which the rule is valid.

System 100 may allow determination of a general prioritization definition, master data related prioritization definitions. In addition, default sources of supply, maintained on different master data, may also be considered. A sourcing list may be sorted according to the prioritization definitions and separated by product, source and target relation of the sources of supply.

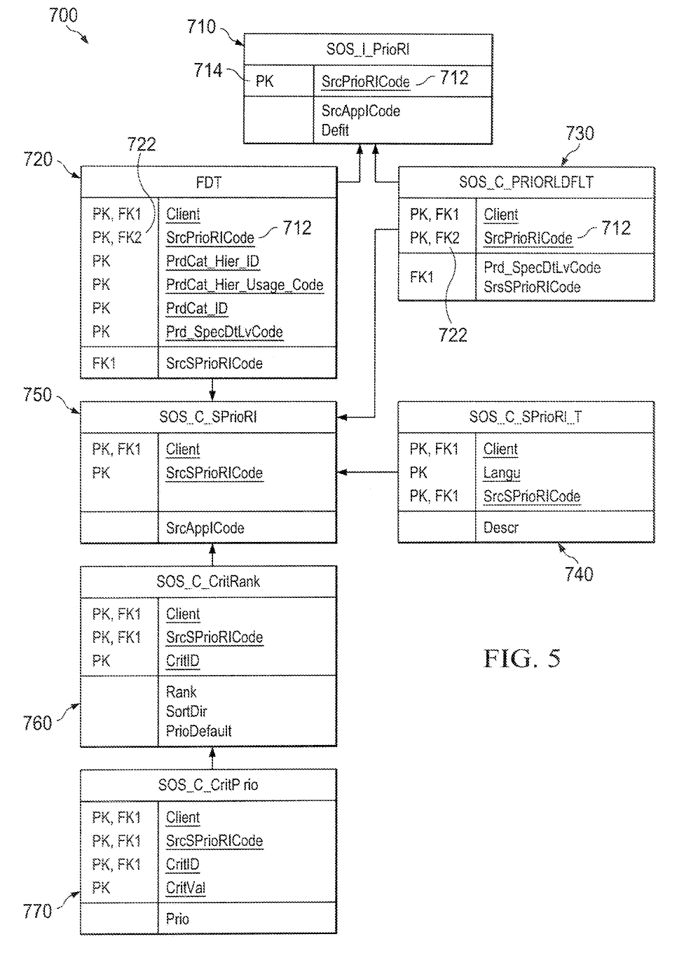

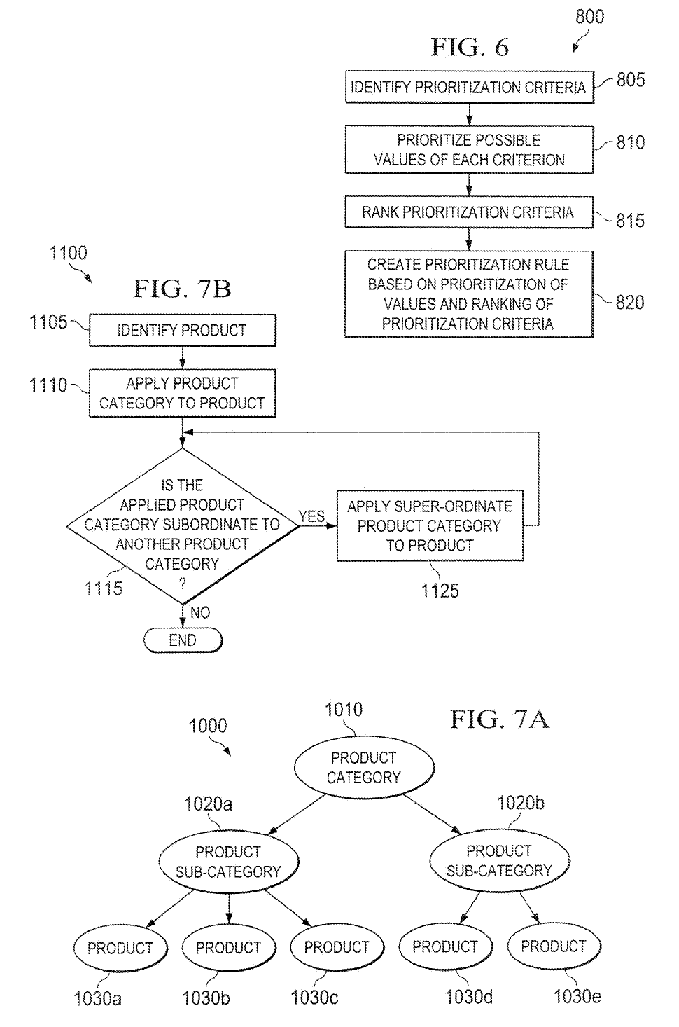

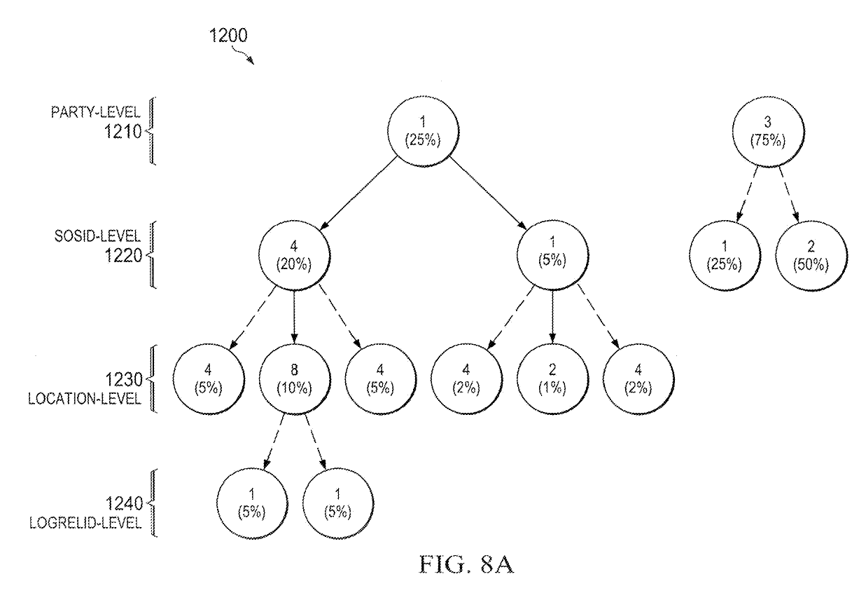

FIG. 6 illustrates an example method 800 of determining sourcing prioritization rules in accordance with the present disclosure. According to the method 800, the first step is step 805, where prioritization criteria are identified. For example, prioritization criteria may be identified by software, received from over a network, or input by a user. In some implementations, prioritization criteria may include procurement type, fulfillment of quota and/or sourcing priority. Next, in step 810, possible values of each criterion are prioritized. Each criteria may have more than one possible value, and a prioritization rule may include a prioritization of those possible values. For example, the prioritization rule may indicate that, for the procurement type prioritization category, internal procurement is preferable to external procurement. Then, in step 815, the prioritization criteria are ranked. A prioritization rule may include a ranking of the identified prioritization criteria, which may indicate an order for sorting sources of supply. In the example, procurement type may be ranked first, fulfillment of quota may be ranked second, and sourcing priority may be ranked third. Of course, any other ranking could be used. Finally, in step 820, a prioritization rule is created based on the prioritization criteria, the prioritization of values, and the ranking of prioritization criteria. Finishing the example, a prioritization rule is created based on the previously received information. The prioritization rule may then be used to sort sources of supply. FIG. 7A illustrates an example hierarchy 1000 of an enriched sources of supply parameter in accordance with the present disclosure. The enrichment of sources of supply parameters allows sources of supply to be determined quickly and efficiently by providing the hierarchy 1000. The illustrated hierarchy 1000 is arranged in three levels and includes a product category 1010, two product sub-categories 1020a and 1020b (collectively 1020), and products 1030. In general, a hierarchy may include any number of layers without departing from the scope of this disclosure. In the illustrated example, products 1030 are sub-ordinate to product sub-categories 1020. Product sub-categories 1020 are sub-ordinate to the product category 1010. The products 1030 are each associated with a product sub-category 1020, which may also be referred to as a direct category. Each product sub-category 1020 is associated with a product category 1010, which may also be referred to as an indirect category. In some implementations a product may be directly associated with a product category 1010. Each product 1030, product sub-category 1020, and product category 1010 may be associated with one or more sources of supply (not illustrated). For example, a source of supply may be associated with product category 1010 and product sub-category 1020b, but not product sub-category 1020a. A different source of supply may be associated only with product sub-category 1020a and product 1030a. When determining a source of supply for product 1030a, all three levels of the hierarchy 1000 may be searched. Sources of supply for product category 1010, product sub-category 1020a and product 1030a may be determined. For example, when determining a source of supply for product 1030a, sources of supply for product 1030a, product sub-category 1020a, and product category 1010 may all be provided.

Turning to a particular example implementation of the hierarchy 1000, the product category 1010 may be ‘dairy products,’ the product sub-category 1020a may be ‘cheese,’ the product sub-category 1020b may be ‘milk,’ and product 1030a may be ‘mozzarella.’ In determining sources of supply for mozzarella cheese, sources of supply for ‘mozzarella,’ ‘cheese’ and ‘dairy products’ may be considered. By considering multiple layers of the hierarchy 1000, a larger number of sources of supply may be determined, which may allow greater flexibility in the determination of sources of supply. In some implementations, sources of supply associated with sub-ordinate objects may be given higher value than super-ordinate objects. For example, when searching for a source of supply of mozzarella cheese, a source of supply of ‘mozzarella’ may be given a higher value than a source of supply of ‘cheese.’

The hierarchy may, in some implementations, allow multiple sources of supply to be determined. Each source of supply may have associated validity ranges and other constraints, which may allow a source of supply to be split across one or more categories. For example, one source of supply may be selected for the first half of a time period (e.g., a month) and a second source of supply may be selected for the second half of the same time period. The validity of splitting of sources of supply over the time period may be checked using the validity ranges for each source of supply. Business checks may also be implemented using enriched data. For example, a hierarchy including multiple levels may be maintained for source of supply parameters such as transport, location, procurement, or others.

FIG. 7B illustrates an example method 1100 for enrichment of sources of supply selection parameters in accordance with the present disclosure. In some implementations, the method 1100 may be used to enrich static selection parameters for sources of supply with super- and/or sub-ordinate objects. The enrichment method 1100 may be used to construct a hierarchy, such as hierarchy 1000, that can be used for determining sources of supply. Method 1100 illustrates the specific example of enriching a product selection. However, a similar method may be used to enrich any other parameter, such as means of transportation or quota arrangement. Indeed, method 1100 is included here as an instructive example of a more general enrichment method, which forms one aspect of the present disclosure.

According to the method 1100, the first step is step 1105, where an identification of a product is received. For example, the product ‘mozzarella cheese’ may be identified. Next, in step 1110, a product category or product sub-category may be applied to the category. For example, the sub-category ‘cheese’ may be applied to the product ‘mozzarella cheese’. In another example, if there were no sub-category ‘cheese,’ the product category ‘dairy products’ may be applied to the product ‘mozzarella cheese’. Next in question 1115, a determination is made whether the previously applied product category is sub-ordinate to another product category. For example, it may be determined that the product sub-category ‘cheese’ is sub-ordinate to the product category ‘dairy products.’ As another example, it may be determined that there are no super-ordinate product categories or super-ordinate product sub-categories associated with ‘dairy products.’ In the case that there is a super-ordinate product category or a super-ordinate product sub-category associated with the previously applied product category or product sub-category, the method returns to step 1115 and proceeds. In the alternative case, the method 1100 terminates.

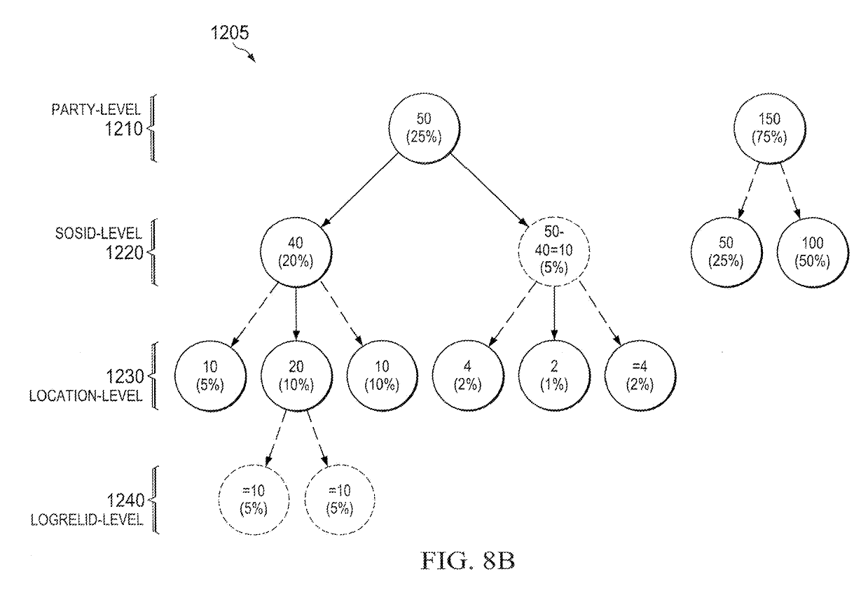

Turning to FIG. 8, selection of supply quota arrangements may use a determination of dynamic selection parameters, which inherit from selected sources of supply or from sources of supply specific objects. Selection of supply quota may also use enrichment of static selection parameters for supply quota arrangements super- and sub-ordinate objects. Supply quota arrangements may be broken down by an algorithm, as shown in FIGS. 8A and 8B. Supply quota arrangements may be selected using business objects Supply Quota Arrangement in one or more steps dependent from the breakdown algorithm. Supply Quota Arrangements may be broken down to relate super-ordinate objects to static or dynamic selection parameters in consideration of nesting (e.g., enriched selection parameters) and validities (e.g., by two specific algorithms). In consideration of validities, sources of supply and supply quota arrangements may be merged into a consolidated sourcing list.

FIGS. 8A and 8B illustrate two example breakdowns of supply quota arrangements in accordance with the present disclosure. FIG. 8A illustrates an example breakdown 1200, and FIG. 8B illustrates an example breakdown 1205. Both the illustrated example breakdowns 1200 and 1205 include four levels, but, in general, a breakdown of supply quota arrangements may include any number of levels, according to the present disclosure. The layers illustrated in FIG. 8 are the party level 1210, an SOSID level 1220, a location level 1230 and a LogRelID level 1240.

It will be understood that the foregoing methods are for illustration purposes only and that the described or similar processes and techniques may be performed at any appropriate time, including concurrently, individually, or in combination. In addition, many of the steps in this disclosure may take place simultaneously and/or in different orders than as shown. Moreover, system 100 may use or implement similar methods with additional steps, fewer steps, and/or different steps, so long as the methods remain appropriate.

Although this disclosure has been described in terms of certain embodiments and generally associated methods, alterations and permutations of these embodiments and methods will be apparent to those skilled in the art. For example, certain embodiments of system 100 may be a standalone, but networked, client that retrieves local information, identifies the context of the local user, and provides presentation elements associated with remote objects, applications, or other data accessible via the network. Accordingly, the above description of example embodiments does not define or constrain this disclosure. Other changes, substitutions, and alterations are also possible without departing from the spirit and scope of this disclosure.

What is claimed is:

1. A computer-implemented method for determining a supply source, comprising:
receiving a request for a source determination for a product;
selecting at least one supply source for the product according to the request;
enriching the selected supply sources with at least one transportation channel and at least one quota arrangement; and
automatically prioritizing the selected supply sources based on at least a first priority rule of a plurality of priority rules, at least one of the priority rules associated with business logic, a category associated with the product, or the product.

2. The method of claim 1 further comprising sorting the prioritized supply sources according to at least one of the following:
numerical static attributes;
non-numerical static attributes;
numerical dynamic attributes; and
non-numerical dynamic attributes.

3. The method of claim 2, the static attributes comprising priority of supply source, procurement type, source object type, and selling party.

4. The method of claim 2, the dynamic attributes comprising costs, lateness, fulfillment of guaranteed minimum value, and quota rate.

5. The method of claim 2, the numerical attributes comprising priority of supply source, costs, lateness, fulfillment of guaranteed minimum value, and quota rate.

6. The method of claim 2, the non-numerical attributes comprising procurement type, source object type, and selling party.

7. The method of claim 1, the selection provided by queries of a supply source business object according to product-specific criteria and recipient-specific criteria.

8. The method of claim 7, wherein:
the product-specific criteria comprises:
product;
product category;
catalogue reference; and
product seller ID; and
the recipient-specific criteria comprises:
recipient business partner;
recipient organizational center;
recipient location;
recipient transportation zone; and
recipient supply planning area.

9. The method of claim 7 further comprising enriching the selection criteria using at least one of the following:
product with product categories;
product with all-product enrichment data;
recipient locations with recipient transportation zones;
recipient locations with higher recipient locations of a location hierarchy; and
recipient supply planning areas with recipient organizational centers.

10. Software for determining a supply source, comprising computer readable instructions embodied on tangible media and operable to:
receive a request for a source determination for a product;
select at least one supply source for the product according to the request;
enrich the selected supply sources with at least one transportation channel and at least one quota arrangement; and
automatically prioritize the selected supply sources based on at least a first priority rule of a plurality of priority rules, at least one of the priority rules associated with business logic, a category associated with the product, or the product.

11. The software of claim 10 further operable to sort the prioritized supply sources according to at least one of the following:
numerical static attributes;
non-numerical static attributes;
numerical dynamic attributes; and
non-numerical dynamic attributes.

12. The software of claim 11, the static attributes comprising priority of supply source, procurement type, source object type, and selling party.

13. The software of claim 11, the dynamic attributes comprising costs, lateness, fulfillment of guaranteed minimum value, and quota rate.

14. The software of claim 11, the numerical attributes comprising priority of supply source, costs, lateness, fulfillment of guaranteed minimum value, and quota rate.

15. The software of claim 11, the non-numerical attributes comprising. procurement type, source object type, and selling party.

16. The software of claim 10, the selection provided by queries of a supply source business object according to product-specific criteria and recipient-specific criteria.

17. The software of claim 16, wherein:
the product-specific criteria comprises:
product;
product category;
catalogue reference; and
product seller ID; and
the recipient-specific criteria comprises:
recipient business partner;
recipient organizational center;
recipient location;
recipient transportation zone; and
recipient supply planning area.

18. The software of claim 16 further operable to enrich the selection criteria using at least one of the following:
product with product categories;
product with all-product enrichment data;
recipient locations with recipient transportation zones;
recipient locations with higher recipient locations of a location hierarchy; and
recipient supply planning areas with recipient organizational centers.

19. Software for utilizing a supply source, comprising computer readable instructions embodied on tangible media and operable to:
transmit a request for a source determination for a product;
receive a plurality of supply sources in response to the request, the received supply sources i) enriched with the selected supply sources with at least one transportation channel and at least one quota arrangement, and ii) prioritized based on at least a first priority rule of a plurality of priority rules, at least one of the priority rules associated with business logic, a category associated with the product, or the product; and
associate at least one of the received supply sources with the product.

20. The software of claim 19, the request enriched using at least one of the following:
product with product categories;
product with all-product enrichment data;
recipient locations with recipient transportation zones;
recipient locations with higher recipient locations of a location hierarchy; and
recipient supply planning areas with recipient organizational center.
